(19) United States
(12) Patent Application Publication
(10) Pub. No.: US 2023/0412868 A1
(43) Pub. Date: Dec. 21, 2023

(54) PERSONAL CINEMA METHOD AND SYSTEMS

(71) Applicant: Patrick Zucchetta, Cagnes-sur-Mer (FR)

(72) Inventor: Patrick Zucchetta, Cagnes-sur-Mer (FR)

(21) Appl. No.: 18/218,783

(22) Filed: Jul. 6, 2023

Related U.S. Application Data
(63) Continuation-in-part of application No. 17/380,058, filed on Jul. 20, 2021.

(51) Int. Cl. H04N 21/43; H04N 21/439; H04N 21/414

(52) U.S. Cl. CPC H04N 21/4302; H04N 21/439; H04N 21/414

(57) ABSTRACT

A digital video system is provided at a cinema with a plurality of personal cinema experience area seats, each of a seat plurality of personal cinema experience area seats is positioned at a selected area of the cinema. A headset is at each of the plurality of personal cinema experience area seats including two embedded mini screens and a lens one or more speakers at each of a seat. a DCI compliant cinema player is coupled to or at each seat of the plurality of personal cinema experience area seat.

This application is continuation in part and claim priority from U.S. Utility application Ser. No. 17/380,058, filed on Jul. 20, 2021, entitled “PERSONAL CINEMA METHOD AND SYSTEMS”.

### BACKGROUND

### Field of the Invention

This invention relates generally to digital cinemas, and more particularly to a digital video cinema system with a headset, at each of the plurality of personal cinema experience area seats, a headset at each of the plurality of personal cinema experience area seats including two embedded mini screens and a lens one or more speakers at each of a seat.

### Description of the Related Art

A multiplex is a movie theater complex with multiple screens within a single complex. They are usually housed in a specially designed building. Sometimes, an existing venue undergoes a renovation where the existing auditoriums are split into smaller ones, or more auditoriums are added in an extension or expansion of the building. The largest of these complexes can sit thousands of people and are sometimes referred to as a megaplex.

Digital cinema refers to adoption of digital technology within the film industry to distribute or project motion pictures as opposed to the historical use of reels of motion picture film, such as 35 mm film. Film reels have to be shipped to movie theaters. A digital movie can be distributed to cinemas in a number of ways: over the Internet or dedicated satellite links, or by sending hard drives or optical discs such as Blu-ray discs. Digital movies are projected using a digital video projector instead of a film projector, are shot using digital movie cameras and edited using a non-linear editing system (NLE).

The NLE is often a video editing application installed in one or more computers that may be networked to access the original footage from a remote server, share or gain access to computing resources for rendering the final video, and to allow several editors to work on the same timeline or project.

Alternatively, a digital movie could be a film reel that has been digitized using a motion picture film scanner and then restored, or, a digital movie could be recorded using a film recorder onto film stock for projection using a traditional film projector. Digital cinema is distinct from high-definition television and does not necessarily use traditional television or other traditional high-definition video standards, aspect ratios, or frame rates. In digital cinema, resolutions are represented by the horizontal pixel count, usually 2K (2048×1080 or 2.2 megapixels) or 4K (4096×2160 or 8.8 megapixels). The 2K and 4K resolutions used in digital cinema projection are often referred to as DCI 2K and DCI 4K. DCI stands for Digital Cinema Initiatives. As digital-cinema technology improved in the early 2010s, most theaters across the world converted to digital video projection.

Digital cinemas can deliver live broadcasts from performances or events. A video projector is used that is an image projector that receives a video signal and projects the corresponding image on a projection display screen using a lens system.

Digital cinema is a method and system for making and showing videos. The basic idea is to use bits and bytes (strings of 1s and 0s) to record, transmit and replay images, rather than using chemicals on film. The main advantage of digital technology (such as a CD) is that it can store, transmit and retrieve a huge amount of information exactly as it was originally recorded. Analog technology loses information in transmission, and generally degrades with each viewing.

Digital cinema affects three major areas of movie-making: production—how the movie is actually made; distribution—how the movie gets from the production company to movie theaters; and projection—how the theater presents the movie.

DCI specifications calls for picture encoding using the ISO/IEC 15444-1 “JPEG2000” (.j2c) standard and use of the CIE XYZ color space at 12 bits per component encoded with a 2.6 gamma applied at projection. Two levels of resolution for both content and projectors are supported: 2K (2048×1080) or 2.2 MP at 24 or 48 frames per second, and 4K (4096×2160) or 8.85 MP at 24 frames per second. The specification ensures that 2K content can play on 4K projectors and vice versa. Smaller resolutions in one direction are also supported (the image gets automatically centered). Later versions of the standard added additional playback rates (like 25 fps in SMPTE mode).

DCI-compliant digital cinema requires a digital projector and a server. A digital file clown as a digital cinema package (DCP). The DCP is copied onto the internal hard drives of the server, which can be via a USB port.

Films are usually encrypted, to prevent illegal copying and piracy. The necessary decryption keys are supplied separately, usually as email attachments and then “ingested” via USB. Keys are time-limited and will expire after the end of the period for which the title has been booked. They are also locked to the hardware (server and projector) that is to display screen the film, so if the theatre wishes to move the title to another display screen or extend the run, a new key must be obtained from the distributor

The playback of the content is controlled by the server using a “playlist”. In addition to listing the content to be played the playlist also includes automation cues that allow the playlist to control the projector, the sound system, and the lighting.

There is a need for a system that enables viewers to experience a personal cinema experience. There is a further need for a digital video cinema system that enables viewers to experience a personal cinema experience at a same location as usual with the same videos in day and date. There is another need for a digital video cinema system that enables viewers to experience a personal cinema experience at a same location as usual with the same videos in day and date in a specific lounge area of their selected cinema, either a s a single or multiple person seat, and with playback under their individual control. Yet there is another need for a digital video cinema system that enables viewers to experience a personal cinema experience that allows viewers to pause the movie, and place the display screen in a position away from them, allowing them to exit their seats.

There is a need for a cinematic system that includes a headset at each of the plurality of personal cinema experience area seats that includes two embedded mini screens and a lens one or more speakers at each of a seat.

### SUMMARY

An object of the present invention is to provide a digital video cinema system that includes a plurality of seats arranged to allow people to experience a social experience and a headset at each of the plurality of personal cinema experience area seats including two embedded mini screens and a lens one or more speakers at each of a seats.

A further object of the present invention is to provide a digital video cinema system that enables viewers to experience a personal cinema experience, and a headset at each of the plurality of personal cinema experience area seats including two embedded mini screens and a lens one or more speakers at each of a seat

A further object of the present invention is to provide a digital video cinema system that enables viewers to experience a personal cinema experience at a same location as usual with the same videos in day and date, and having a headset at each of the plurality of personal cinema experience area seats including two embedded mini screens and a lens one or more speakers at each of a seat.

These and other objects of the present invention are achieved at a digital video system at a cinema with a plurality of personal cinema experience area seats, each of a seat plurality of personal cinema experience area seats is positioned at a selected area of the cinema. A headset is at each of the plurality of personal cinema experience area seats including two embedded mini screens and a lens one or more speakers at each of a seat. a DCI compliant cinema player is coupled to or at each seat of the plurality of personal cinema experience area seat.

### BRIEF DESCRIPTION OF THE DRAWINGS

FIG. 1 is a block diagram illustrating an example of a digital cinema system using an embodiment of the present invention.

FIGS. 2 and 3 illustrate embodiments of a seat with a base, an associated screen, adjustment movement mechanism and speakers.

FIG. 4 illustrates one embodiment of a personal cinema experience area of a cinema wherein viewers of a program can select one or more programs to view.

FIG. 5 illustrates one embodiment of a digital cinema system of the present invention.

FIG. 6 illustrates another embodiment of a digital cinema system of the present invention.

FIG. 7 illustrates one embodiment of a server used in various embodiment of the present invention. using an embodiment of the present invention.

FIG. 8 illustrates one embodiment of a distribution system that can be used with the present invention.

FIG. 9 illustrates one embodiment of composition playlist that can be used with the present invention.

FIG. 10 illustrates one embodiment of a sound element that can be used with the present invention.

FIG. 11 illustrates another embodiment of a soundtrack file asset type structure that can be used with the present invention.

FIG. 12 illustrates one embodiment of a digital cinema package that can be used with the present invention.

FIGS. 13, 14(a) and 14(b) illustrates one embodiment of a headset with two mini screens and a lens.

FIG. 15 illustrates one example for viewing streaming video that can be cloud based.

FIG. 16 illustrates further aspects of the example system environment for live streaming of video using the cloud.

FIGS. 17(a) and 17(b) are timing diagrams illustrating a technique for establishing a peer connection between a media gateway in the cloud and a client-side streaming console

### DETAILED DESCRIPTION

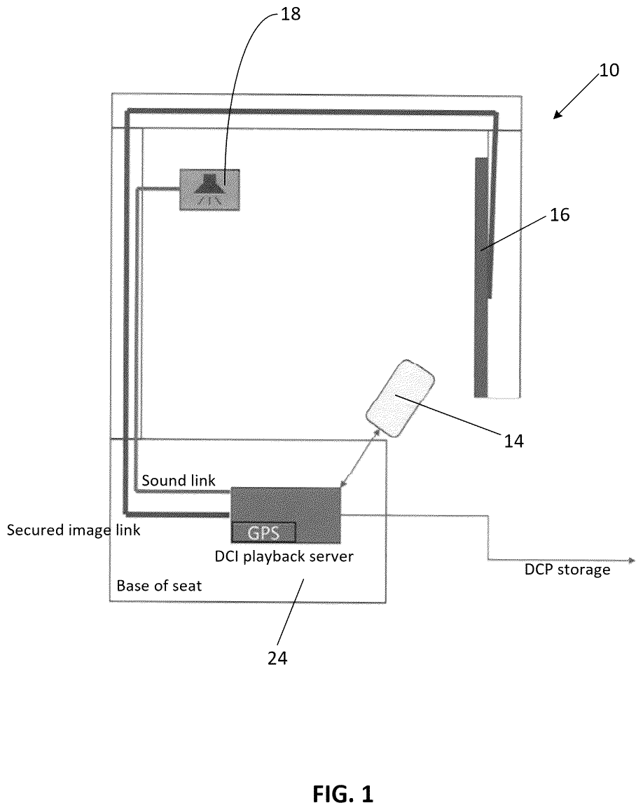

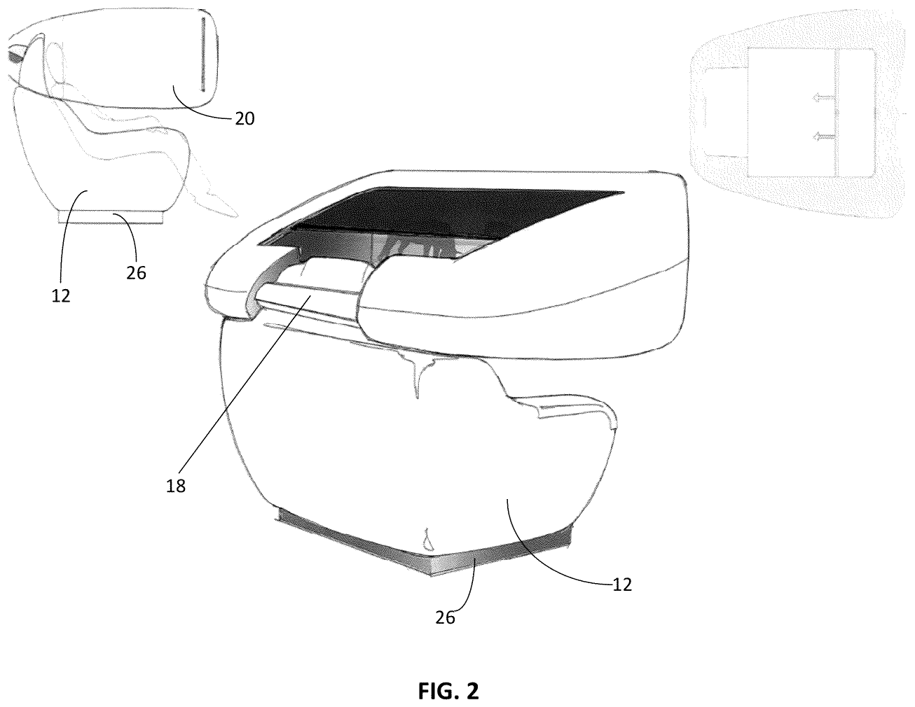

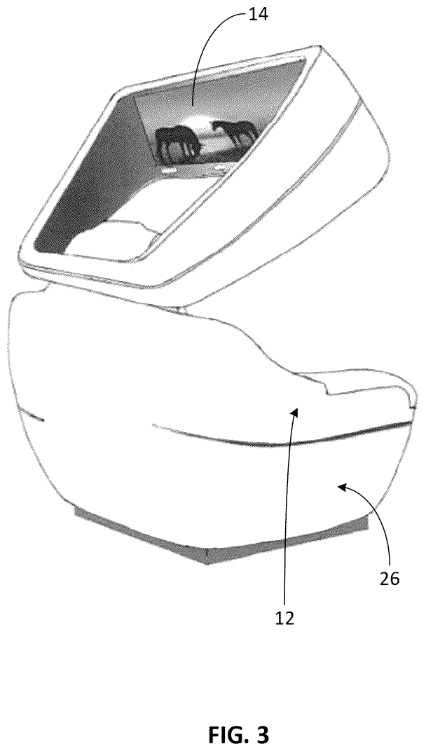

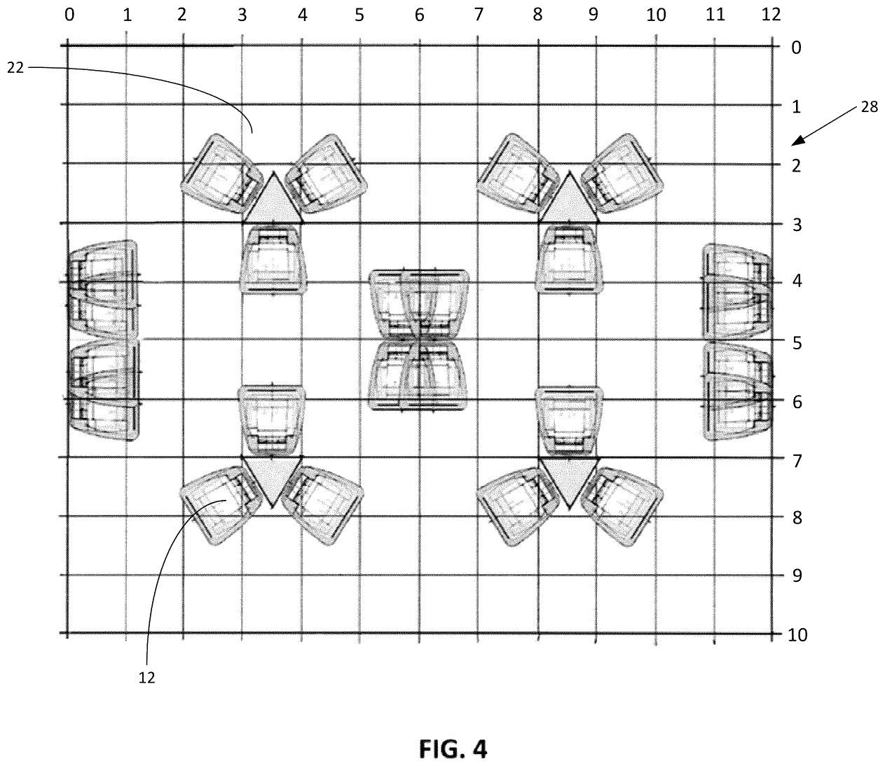

As illustrated in FIGS. 1 through 4, in one embodiment, a digital video system 10 includes a personal cinema experience area seat 12, each with a display screen 14 for reviewing a video program, including but not limited to a digital video. As non-limiting examples, the program (program material), from a content provider, can be a movie and audio and/or other related information synchronized with it. Such related information may include, for example, a special visual signal channel for the visually impaired, subtitling for a different language and/or hearing-impaired audience, or a multimedia channel. The program can be long (such as feature films) or short (such as clips or so-called previews), or it can be still (such as ads or announcements). For purposes of this application, the personal cinema experience area is an area and or decision by one or more persons to view any selected video, in relative privacy, that is playing at a cinema, can be streamed to an area of the cinema, and the like. It provides a private experience for viewing in a selected viewing area at the personal cinema experience area, it is a decision by one or two persons which video/movie to watch, it can be outside of the main room, but it is a special area, a private viewing area e.g., a special area of a theater or other venue, called the personal cinema experience area 28 of the theater (hereafter “PCEA”), venue and the like.

Each seat 12 has a similar DCI quality experience but provides for a personal cinema experience with individual viewer control of user interface 14. A special designed emissive screen 16, compliant with the DCI display rules in terms of visual quality experience (DCI/CTP compliance), is provided for each seat 12. As a non-limiting example, the user interface 14 runs on a tablet, including but not limited to a IPAD tablet, in order to browse through the day, time, a list of videos shown at the theater site, as well as those available to be streamed into the theater. As a non-limiting example, a viewer can view videos available at the theater site, by selecting a title, playing it, and can also pause it. The pausing can be achieved by entering a entering a booking code valid for a selected number of video playbacks.

In one embodiment, a multiplex's DCP Library is periodically refreshed with new DCPs for Big Screens of the site and the Cocoon Lounge area. Those DCP are then made available for the Cocoon Seat DCI players (Stream or copy). Each of a set can include a GUI tablets, including but not limited to an iPad, and the like, that is updated with new contents (DCPs) that are available.

Viewers (viewers) book online at a cinema website to reserve a timeslot (not a movie but a timeslot), They then receive a valid ticket (QR code). The reservation can be made for one or more seats. Once in Cocoon Lounge, the goes to any available Seat (selecting one or more seats according to its ticket, and scans the QR code to unlock a playback session (timeslot);

During the unlock time slot, viewer can watch movies or pause movie (and go to dedicated local concession bar. In one embodiment, the time slot allows for movie time plus breaks. In one embodiment, the viewer can reserve several time slots when booking and then can watch multiple movies in one experience session.

As a non-limiting example, a data center is a pool of resources (computational, storage, network) interconnected using a communication network. Data Center Network (DCN) holds a pivotal role in a data center, as it interconnects all of the data center resources together. DCNs need to be scalable and efficient to connect tens or even hundreds of thousands of servers to handle the growing demands of cCloud computing. As a non-limiting example, data centers can be constrained by the interconnection network.

A variety of different data center network topologies can be used, including but not limited to: fixed topology and flexible technology. Fixed topology can include: tree based; recursive, and the like. As a non-limiting example, tree based can include: a basic tree, clos network, VL2, fat-free, portland, and hedera. Flexible topology can include: fully optical (OSA optical switching architecture; hybrid, c-through, helios and the like.

As a non-limiting example, Data Center Interconnect (DCI) technology connects two or more data centers together over short, medium, or long distances using high-speed packet-optical connectivity.

Data Centers house compute and storage resources for applications, data, and content. And in this cloud-based, application-centric world, access to that data is a critical challenge.

Data Centers communicate with each other to share data and content and provide back-ups for redundancy. DCI enables the transit of critical assets over any distance, from across town to ultra-long trans-Pacific or trans-Atlantic oceanic links and everything in-between. Data can be carried across simple, point-to-point connections, more robust ROADM-based networks, or open line systems which support transport interfaces sourced from multiple vendors.

In one embodiment, transport technology for DCI is next-generation coherent optics to provide high speeds of up to 800 Gb/s per wavelength. With a fast, reliable connection in place, physically separate data centers can share resources and balance workloads.

Some large operations use DCI to connect their own data centers within their extended enterprise infrastructures, while others connect to partners, cloud providers or data center operators to simplify data and resource sharing or handle disaster recovery needs. Subsea cables are used to connect data centers and internet exchanges between countries and continents separated by vast oceans.

As a non-limiting example, DCI applications can require the highest level of capacity and scalability along with more software control and automation, while others can trade off some performance to meet a specific power profile and form-factor. Performance optimized DCI solutions may be used to overcome scalability and distance constraints to deliver higher capacity connectivity.

Distance: DCI applications can vary greatly in size and scope. Data centers may be dispersed across a metro area, around a country, or all over the globe. Having enough performance to interconnect them while carrying the most bits the farthest is critical. Performance optimized coherent technology can transport more capacity at any distance, offering programmable interfaces with selectable baud and different modulation schemes to fine tune capacity for any application. In addition, for ROADM-based networks that provide greater flexibility and resiliency, performance optimized solutions offer the capability to transit multiple ROADM nodes across short metro links, as well as long-haul haul routes between major cities.

In one embodiment, data centers store and deliver the data that applications require. Data sets coming into or leaving a data center can be very large—from hundreds of Gigabits to Terabits. Routers are moving from 100 GbE to higher speed 400 GbE services. To handle these growing bandwidth demands, networking equipment must provide reliable, high-capacity connections that scale simply and quickly. Optics can be used for data to move at rates up to 800 Gb/s on a single wavelength, increasing DCI capacity to a new industry benchmark. Modern photonic line systems offer the ability to expand the usable spectrum from the C-band to include the L-band for double the capacity per fiber, allowing more wavelengths between data centers in fiber constrained or high growth areas.

In one embodiment, DCI can shrink the size of the coherent Digital Signal Processor (DSP) and electro-optics to fit within a standards-based pluggable form-factor. These pluggable interfaces provide IP/Optical integration without reducing faceplate density or stranding packet switching capacity. Footprint optimized solutions are attractive for access, edge, and metro DCI applications where spectral efficiency is less of a concern and service density, reduced power consumption, and smallest footprint are critical.

DCI technology sits at the center of the cloud-centric world, providing the network capacity for users and applications to connect to storage, compute, and content resources.

In one embodiment, each seat 12 is associated with an immersive binaural headphone 20. As a non-limited example each seat 12 is associated with speakers 20 that play an immersive sound track (Atmos or DTS:X) to the seat occupant. In one embodiment, each seat 12 includes active seat localization 22 that determines if the seat 12 has been moved and prevents any further playback by breaking what is called a «DCI marriage» until a technician enables further playing. In one embodiment, a movement mechanism allows 18 for up, down, and sideways movement of a display screen in order for individual to see the display screen 14 at a desired position. As a non-limiting example, the movement mechanism 18 allows a viewer to lift up the screen, in direct to your height, for view. In one embodiment, the movement mechanism 18 allows for lifting up the display screen 14, relative to one's height, and for the purpose of allowing a competent display screen angle of view desired by the viewer. As a non-limiting example, the movement mechanism 18 allows for angular 90° up/down movement, as well as side to side movement, of the display screen 14, including but not limited to 45°-120°, 60°-100°, 80°-90°, 90° and the like.

In one embodiment, a DCI compliant cinema player 24 is provided for each seat. As a non-limiting example, the DCI can be at a base 26 of the seat 12. In one embodiment the server is a DCI server. A plurality of servers is provided, each located at a seat. In one embodiment, the server and the screen are secured together connected using video links. As a non-limiting example, the video links Link to on-line or off-line videos and comply with copyright rules. Videos of newscasts, television shows, films, music videos, advertisements, and the link can be provided with the video links.

In one embodiment each seat 12 has its own server, and can have a high bandwidth which as non-limiting examples can be 4-10 gigabits 5-8 gigabits, 6 or 7 gigabits, and the like. A variety of different servers can be used, including but not limited to: Cygwin/X; KDrive; Low Bandwidth X; MacX; Mir (display server); MKS X/Server; Multi-Pointer X; Reflection X; RISCwindows; WeirdX; WiredX; X Window System; X-Win32; X.org Server; X386; Xapollo; XDarwin; Xephyr; XFree86; Xming; Xmove; Xnest; Xnews (X11 server); Xpra; XQuartzXsgi; Xsan; Xvfb, and the like.

A plurality of seats 12 are provided that can be used by a determined number of people, including but not limited to one, two, and the like. In one embodiment, the arrangement and distance between seats 12 maintains a selected, desired distance, which as a non-limiting example, can be a social distance of 6 feet or less. As a non-limiting example, each seat 12 is positioned and installed in the PCEA 28.

In one embodiment, system 10 includes one or more tracking devices 16, including but not limited to a camera 18 located and monitoring the PCEA.

In one embodiment, a central DCP library database, video storage 20 can be linked in a network 22 to each seat 12. The library database or storage 20 can include a plurality of different videos, movies, concerts, and the like, that are or can be displayed at the theater, and/or available to the theater but not currently shown. The videos can be from the video storage 20, which can be cloud based. The videos can also be transmitted or broadcasted or sent by a satellite 19 to the display screens 14. In one embodiment, each display screen 14 is an emissive screen, compliant with the DCI display rules in terms of visual quality and the like (DCI/CTP compliance) A cinema audio rendering, in first generation using an immersive binaural headphone 20, able from two array speakers 20 to play an immersive sound track at each of a seat 12. As a non-limiting example, the sound is provided from any source from as long the sound and its volume is constrained around the person at the seat 12, and there is little or no disturbance of nearby seat occupants. In one embodiment, surround sound is used and cam be a technique for enriching the fidelity and depth of sound reproduction by using multiple audio channels from speakers that surround the listener (surround channels). In one embodiment, surround sound adds one or more channels from loudspeakers to the side or behind the listener that are able to create the sensation of sound coming from any horizontal direction (at ground level) around the listener.

In one embodiment, surround sound formats vary in reproduction and recording methods, along with the number and positioning of additional channels. In one embodiment, the sound specification is the ITU's 5.1 standard, calls for 6 speakers: Center (C), in front of the listener; Left (L) and Right (R), at angles of 60°; Left Surround (LS) and Right Surround (RS) at angles of 100-120°; and a subwoofer, whose position is not critical.

In one embodiment, a surround sound has a listener location (sweet spot) where the audio effects work best, and presents a fixed or forward perspective of the sound field to the seat occupant at this location. The technique enhances the perception of sound spatialization by exploiting sound localization: a listener's ability to identify the location or origin of a detected sound in direction and distance. This is achieved by using multiple discrete audio channels routed to an array of loudspeakers.[

In one embodiment, the videos, including image and audio programs are transmitted from a theater and/or venue, or from an outside source to the play screens. As a non-limiting example, the videos can be encoded and encrypted at a central station, and then distributed to the play screens 14. The program (program material), from the content provider, usually consists of a movie and audio and/or other related information synchronized with it. Such related information may include, for example, a special visual signal channel for the visually impaired, subtitling for a different language and/or hearing-impaired audience, or a multimedia channel. The program can be long (such as feature films) or short (such as clips or so-called previews), or it can be still (such as ads or announcements.

In one embodiment, one or more tracking devices 18, including but not limited to cameras 18 are used in the PCEA 28. As a non-limiting example, a target field (camera's view) is viewed based on a shortest distance-based association. In one embodiment, people in the PCEA 28 are given an ID, which can be temporarily, and randomly. In this manner, tracking can be done in PCEA 28 to preserve a person's anonymity.

In one embodiment, system 10 provides data logging. Pixel location coordinates of the detected people within the target field (camera's view) of the PCEA 28, along with their unique tracking IDs are logged with timestamps in files that are stored locally in on-board memory. The files are preserved until their contents have been successfully transmitted to a server that can be cloud based.

In one embodiment of or more of the following can located at the PCEA 28, at an equipment room of the cinema, a combination thereof, and the like: a content delivery system 100; a plurality of servers each associated with a seat 10, a central storage server 130; a fast network, fast internet lines, 5 G, satellite transmission system 120; tape transmission system 110; network interface 150; security system 170; cinema projector; central processing system; auxiliary media signal (eg, an auxiliary soundtrack signal); cinema server 230; antenna 250; auxiliar media device 260; input interface 310; screening processor 320; memory 322; storage device 324; speech output driver 340; caption output driver 345; coprocessors 350; secondary transmitter 390; controller 360; fabrication and distribution system 400: packaging system 420; key generation system 430; auxiliary sound asset 540; auxiliary soundtrack file 560; main soundtrack file 550; auxiliary soundtrack file 560; auxiliary sound track file asset type structure 700; tracked element 710; and the like.

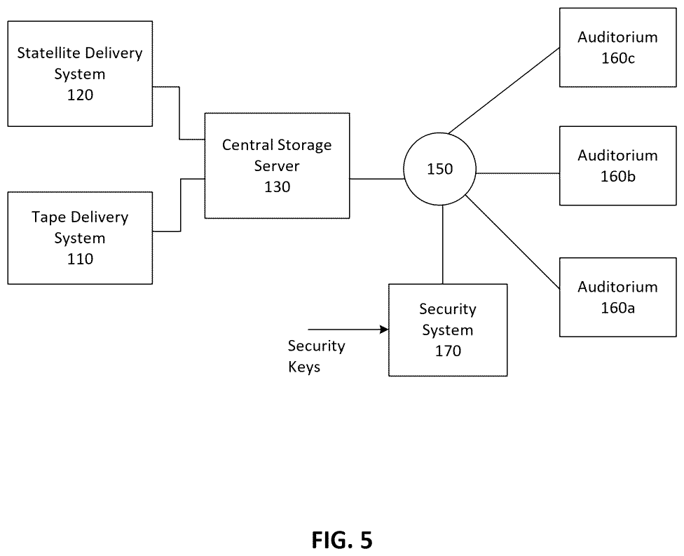

Referring now to FIG. 5 from, shown is a block diagram illustrating one embodiment, of a system using one embodiment of the present invention, illustrates a content delivery system 100 used to deliver digital cinema content. A digital cinema package (DCP) is provided to the central storage server 130. DCP can be provided to a central storage server using a number of transmission systems including tape, disk, topological, wireless or wired systems. In one embodiment, DCP information is provided to the central storage server 130 via the satellite transmission system 120, and the tape transmission system 110 is used as a backup. As will be described in detail below, the DCP includes an essence file including compressed and encrypted track files containing audio, video, and captions, in addition to a list of instructions indicating how the track file will be played.

The central storage server 130 provides the DCP to one or more theaters 160 and to one or more sears 12 via a network using the network interface 150. In one embodiment, network interface 150 is an Ethernet hub.

In order to prevent unauthorized reception of the DCP from the central storage server 130, a security system 170 may be provided. The security key may be generated together with the transmission system 100 or may be generated separately from the transmission system 100. In one embodiment, the security key is provided by the DCP content provider based on valid authorization information about both the content and the theater using the content. In addition, each of these keys may be associated with only one of the theaters 160a, 160b, 160c to prevent content from being transmitted without authorization to any of the remaining theaters.

Theaters may request the DCP, already have it, and may receive the DCP according to a transmission schedule provided by either central storage server 130 or an additional theater content manager (not shown). Theater 160 processes this DCP to provide the audience with media for both voice and video. In addition, the theaters 160 may transmit any supplemental content provided to the audience by the DCP.

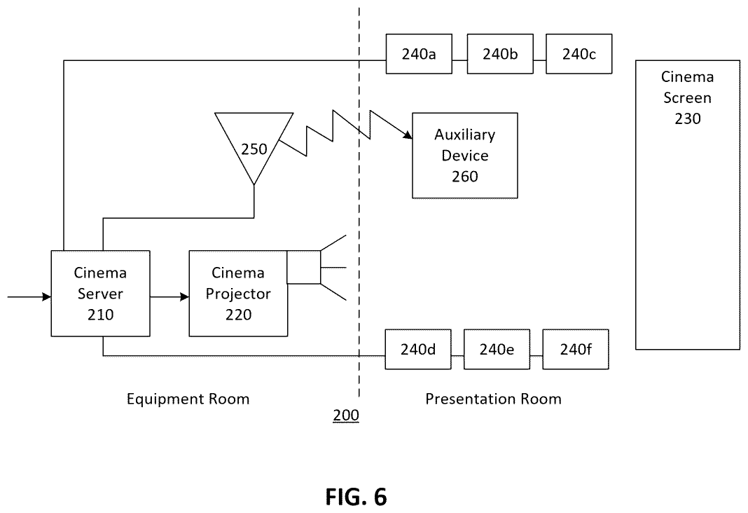

Referring now to FIG. 6, a block diagram illustrates an example of a theater system 200 using one embodiment of the present invention. The theater 200 is often divided into several rooms. In one embodiment, the theater 200 is divided into a screening room and an equipment room. The screening room is used by the audience of the theater 200 during the screening of a movie or the like. The equipment room is a space used by the driver of the theater 200 to store most of the equipment necessary for the screening, and customers usually do not have access to this space.

The DCP signal is provided to the cinema server 210 located in the equipment room of the theater 200 through a network interface. The cinema server 210 provides the signal processing necessary to separate the various elements of the DCP stream into appropriate video, audio, and caption signals for screening. In addition, the cinema server 210 may provide any video signal formatting that is required, such as converting the video signal to the correct format and aspect ratio so that it can be shown in the screening room of the theater 200. In addition, the cinema server 210 may process and convert voice signals to separate and further generate multiple voice channels required for the adopted voice playback system.

The cinema server 210 also separates and manages any auxiliary media provided over the DCP stream. The cinema server 210 sets any transmission timing of the auxiliary media content by decoding the synchronization information provided in the DCP.

The image content signal output from the cinema server 210 is provided to the cinema projector 220. The cinema projector 220 receives the image content signal and generates a light emitting image output to be displayed on the cinema screen 230 located in the screening room of the theater 200. In one embodiment, the cinema projector 220 receives an image content signal in the form of a digital data stream representing luminance levels of three colors, i.e., red, green and blue. Image information associated with each of these colors is provided separately by a digital light projection (DLP) circuit using a high intensity polarization source, in which two rooms of the theater 200 generate and project an image through an opening in an adjacent wall.

A projection light source representing the cinema screened image is projected onto the other end of the screening room of the theater 200 and displayed on the cinema screen 230.

Descriptive caption content signals from the cinema server 210 may also be provided to the cinema projector 220. The cinema projector 220 receives the caption wall. content signal, combines the caption wall. content signal with the video content signal, generates a light emitting video output, and displays it on the cinema screen 230 located in the screening room of the theater 200. To be.

The audio content signal from the cinema server 210 is provided to the speakers 20 240a-240f located in the screening room of the theater 200. Speakers 240a-240f may include additional signal processing, such as speech equalization and/or amplification. Alternatively, the voice content signal may use a central processing system (not shown) for voice compensation and amplification. The central processing system may provide the compensated and amplified signals to the speakers 20 240a-240f. The number and location of speakers 20 used in the showroom will vary depending on the requirements and design. In one embodiment, six speakers 20 240a-240f are placed on each side wall of the theater 200 screening room. These speakers 20 240a-240f are located at equal intervals along the side and are disposed perpendicular to the cinema screen 230.

An auxiliary media signal (eg, an auxiliary soundtrack signal) from the cinema server 210 is provided to the antenna 250. Cinema server 230 may include any signal processing including signal amplification to provide an auxiliary media signal in a condition suitable for transmission by antenna 250. Alternatively, individual amplifiers (not shown) may process and amplify the auxiliary media signal prior to transmission. Such a transmission method may involve a protocol associated with a wireless network system such as Wi-Fi. Such a transmission method may also involve the use of mobile telephone network communications. Such a transmission method may also involve suitable measures using analog or digital communication techniques such as frequency modulation (FM) or quadrature phase shift keying (QPSK).

The auxiliary media signal may be transmitted from the antenna 250 and received by the auxiliary media device 260. The auxiliary media device 260 receives the auxiliary media signal, decodes the auxiliary media signal, and provides the auxiliary media signal to the audience through the electronic media device. The secondary media device 260 may be implemented as a wireless network or Wi-Fi terminal, headphones 20, mobile phone, pager or any suitable communication device.

Other transmission systems for providing auxiliary media signals (eg, auxiliary soundtrack signals) may be used. For example, the auxiliary media signal may be to seat speakers 20.

The secondary media device 260 can include a display and some type of audio driver, such as a speaker or headphone connection. The auxiliary media device 260 may further include a user control device for allowing the viewer to control the operation.

The cinema server 210 may further include receiver circuitry and may include processing to determine and maintain a roster of auxiliary media devices 260 being used in the theater 200. In addition, the cinema server 210 may transmit the auxiliary audio track only to customers who want to receive the auxiliary audio track through the identifier signal for the auxiliary media device.

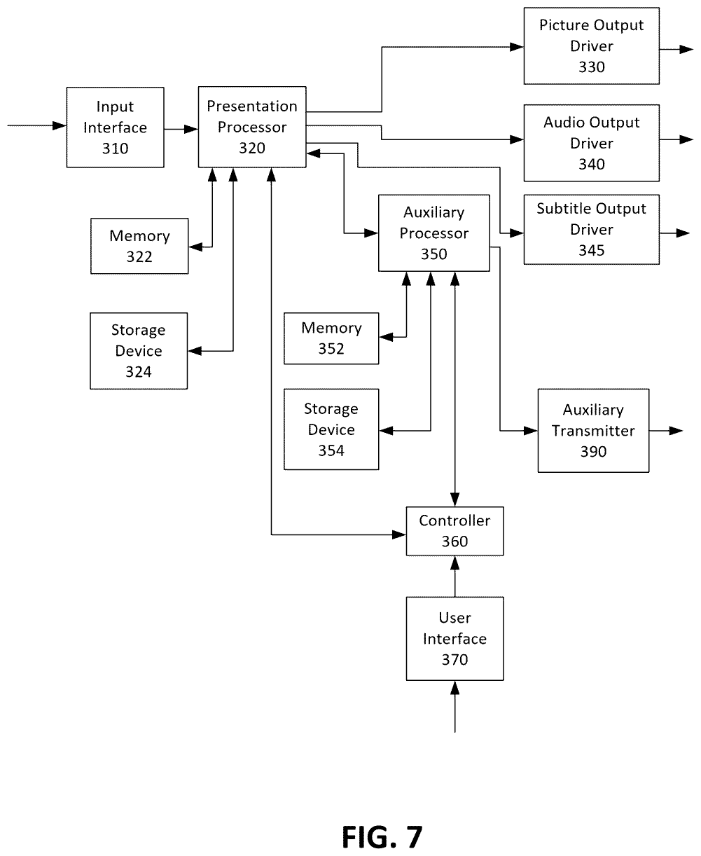

Referring now to FIG. 7, shown is a block diagram illustrating an example of a cinema server 300 using one embodiment of the present invention. The cinema server 300 has the capability to process the DCP. An input data stream representing the DCP is input via input interface 310. The input interface 310 provides the necessary signal conversion from the transport format and signaling protocol to the data interface for easier processing within the cinema server 300. In one embodiment, input interface 310 may provide conversion from an Ethernet signal format to a parallel 8-bit bus signal format.

The transformed data stream from the input interface 310 is provided to the screening processor 320. The screening processor 320 separates the converted data stream into separate sets of screening content such as video, audio, captions, and auxiliary media content. Screening processor 320 also separates and decodes any code instructions provided as part of the DCP. Screening processor 320 acts on the input translation data stream following the code instructions provided within the DCP. The screening processor 320 may operate using instructions included therein. In addition, the screening processor 320 may separate and decode any security information and perform functions such as key authorization for effective reception of the DCP. Screening processor 320 may also perform initial signal processing for the individual screened content.

In addition, the screening processor 320 processes content synchronization information for screening. This synchronization information may be provided with or as part of an instruction provided to the DCP. Subsequently, synchronization of the content based on the instructions in the DCP structure and the instructions in the screening processor 320 proceeds. In addition, the time-based information required to perform this synchronization may be given within an instruction provided to the DCP, or alternatively, may be generated by the screening processor 320.

The memory 322 may be connected to the screening processor 320. The memory 322 may store not only a portion of the show signal but also a portion of the input transform data stream to facilitate content synchronization. The memory 322 may also be used to store control information and operation codes for the screening processor 320 as well as intermediate calculations for any processing. In one embodiment, memory 322 is in the form of RAM and is used to meet memory requirements. In another embodiment, the memory 322 includes RAM for controlling the operation of the screening processor 320 as well as storing data streams and portions of the screening signals. The ROM is used to store initialization and control software for the screening processor 320.

Memory 322 may also store important security information such as keys or algorithms. Some of the security information may be stored in either RAM or ROM. As is well known to those skilled in the art, it should be appreciated that some other methods of storing and retrieving security information may also be used.

Storage device 324 may also be connected to screening processor 320. Storage device 324 has a larger storage capacity than memory 322 and can store for longer periods of time. Storage device 324 can be used to store more portions of the input transform data stream. Alternatively, the storage device 324 can store the entire DCP, allowing the cinema server 300 to download the DCP completely prior to DCP processing using the screening processor 320. In one embodiment, the storage device 324 is a hard disk drive.

The screening processor 320 outputs some screening signals including video, audio, and caption screening signals necessary for screening.

An image display output signal from the screening processor 320 is provided to the image output driver 330. In one embodiment, the image showing output signal is a digital image signal and the image output driver 330 provides the image showing output signal to the cinema projector 220 for projection onto the cinema screen 230.

A speech output signal from the screen processor 320 is provided to the speech output driver 340. The voice output driver 340 provides a voice screening signal to the speakers (20) 240a-240f.

The caption 8-bit output signal from the screening processor 320 is provided to the caption 8-bit output driver 345. The caption output driver 345 provides the cinematic subtitle output signal to the cinema projector 220 for projection onto the cinema screen 230.

An auxiliary media output signal (eg, an auxiliary soundtrack signal) from the screening processor 320 is provided to the auxiliary processor 350. Coprocessor 350 performs any further processing on the auxiliary media output signal, if necessary. The coprocessor 350 manages an auxiliary sound media output signal and also manages any additional auxiliary data.

Although screening processor 320 and coprocessor 350 are illustrated as separate processors, it should be appreciated that these processors may be combined into one processor, as is known to those skilled in the art.

The auxiliary media signal is output from the auxiliary processor 350 to the auxiliary transmitter 390. The secondary transmitter 390 can format the secondary media signal into a suitable transmission signal, such as a QPSK signal. In addition, the auxiliary transmitter 390 may process the transmitted signal to add elements such as error correction required for a particular transmission standard or well known to those skilled in the art. As mentioned above, the auxiliary media signal may be transmitted in a wired manner, such as through a wired network to a speaker in a soundproof room or to a speaker disposed in a theater seat. When the auxiliary media signal is transmitted in a wired manner, the auxiliary transmitter 390 may be replaced by an auxiliary driver as known to those skilled in the art.

The memory 352 may be connected to the coprocessor 350. The memory 352 may primarily store some or any additional auxiliary data of the auxiliary media content to facilitate content synchronization. The memory 352 may also be used to store control information and operation codes for the coprocessor 350 as well as intermediate calculations for any processing. In one embodiment, memory 352 is in the form of RAM and is used to meet memory requirements. In another embodiment, memory 352 includes RAM for controlling the operation of coprocessor 350 as well as storing portions of auxiliary media content. The ROM is used to store initialization and control software for the coprocessor 350.

Storage device 354 is also connected to coprocessor 350. The storage device 354 has a larger storage capacity than the memory 352 and can store for a longer time. Storage device 354 may be used to store more portion of auxiliary media content. Alternatively, the storage device 354 may store additional auxiliary media content provided to or generated by the cinema server. The storage device 354 allows the cinema server 300 to receive additional auxiliary media content intact during the time prior to transmitting the content to the auxiliary audio track in connection with the showing. In one embodiment, the storage device 354 is a hard disk drive.

Controller 360 is connected to both screening processor 320 and coprocessor 350. The controller 360 can manage the interaction between these two processors as well as execute or process instructions passed with the DCP. Controller 360 may maintain an identifier for a device capable of transmitting and/or receiving auxiliary media. Also, the controller 360 can process the return data.

The user interface 370 is connected to the controller 360, and allows control information between the person who controls or controls the screening and the cinema server 300 to interact. User interface 370 allows the control display monitor, touch screen system, mouse and/or keyboard to be externally connected.

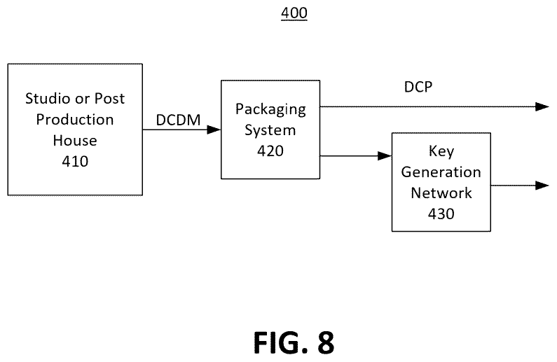

Referring now to FIG. 8, an example of a fabrication and distribution system 400 including an embodiment of the present invention is shown. The system 400 includes a studio or edit room 410, a packaging system 420, and a key generation system 430.

Digital editing of the film is performed in the studio or the editing room 410. More specifically, the film is scanned in digital format from the camera-film disc via a scanner or high-resolution telecine. Alternatively, data from a digital movie camera can be converted into an image file format that is convenient for processing. All of these files are matched to the edit list created by the film editor and then color corrected under the guidance of the studio staff. The final result of the edit is DI (digital intermediate). DI can be used to record movies on film or as the basis for digital film releases. When all of the audio for production (eg, the main soundtrack and all the subsidiary soundtracks), video and data elements are completed, they can be gathered into a Digital Cinema Distribution Master (DCDM) that includes all of the digital material needed for the show. The mastering step for generating the DCDM may be done in the studio or the editing room, or may be done outside the studio or the editing room.

DCDM is sent to packaging system 420. The packaging system 420 compresses, encrypts, and packages the video, audio, and caption subtitles included in the DCDM according to embodiments of the present invention to form a digital cinema package (DCP). This DCP includes an essence to be provided, including a compressed and encrypted track file containing audio, video and descriptive caption data, and, in particular, an organization list (CPL) indicating how this track file will be played.

The DCP is transmitted from the packaging system 420 to the central storage server 130 in different ways, which may include a hard drive, DVD or satellite, as described above. The packaging system 420 may also interact with the key generation network 430 such that the appropriate encryption key is passed to the digital cinema theater (ie, security system 170 associated with the digital cinema theater).

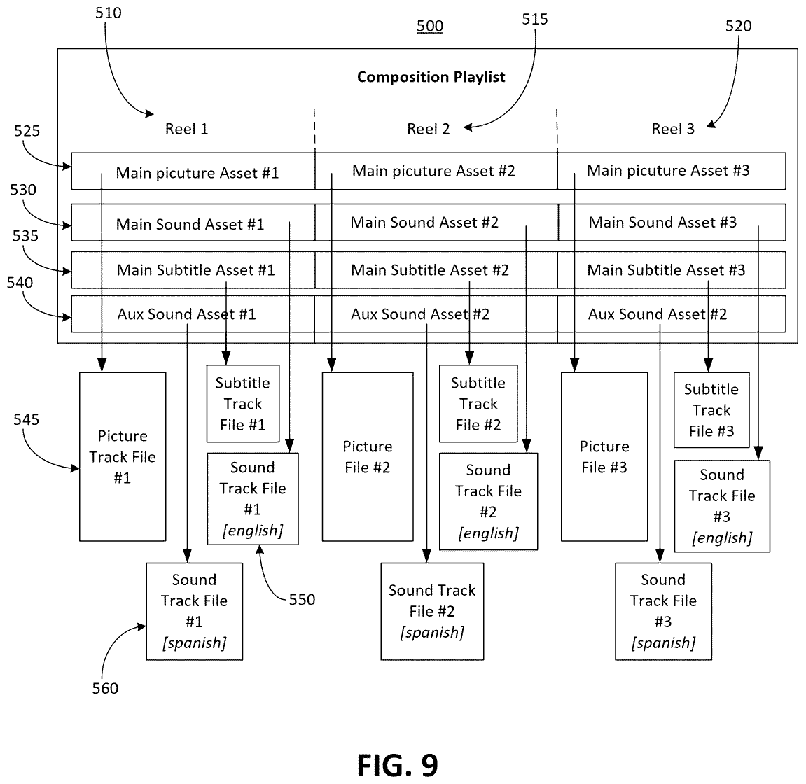

Referring now to FIG. 9, shown is an example of a CPL 500 that includes one embodiment of the present invention. The CPL 500 is arranged in the sorting order of the reels 510-520. Each reel 510-520 may include one of a main video asset 525, a main sound asset 530, a main subtitle asset 535, and an auxiliary sound asset 540, in accordance with an embodiment of the present invention. It contains the above media assets. Each asset 525-540 in a given reel 510-520 is linked to a track file 545-560 containing the essence to be played in parallel. More specifically, each reel 510-520 in CPL 500 preferably includes one main sound asset 530 linked to one soundtrack file 550. The soundtrack file 550 identified by main sound asset 530 includes a sound essence to be played in theater 200, usually through main sound systems 240a-240f.

The auxiliary sound asset 540 is linked to an auxiliary soundtrack file 560 that includes sound essences that are not previously included in the main soundtrack file 550, according to one embodiment of the invention. Although only one auxiliary sound asset 540 and an auxiliary soundtrack file 560 are shown, a plurality of auxiliary sound assets and soundtrack files may be provided. Examples of auxiliary sound essences include, but are not limited to, foreign soundtracks and narration sounds for digital cinema screenings. As mentioned in the description of FIG. 6, the auxiliary sound may be played through the auxiliary device 260 (eg, headphones) in the theater 200.

Note that the auxiliary sound has the same operating constraints as the main sound. This enables the reuse of soundtrack files 550 and 560 in the CPL as either main or auxiliary sound, as described in detail below. It should also be noted that the auxiliary sound preferably has the same audio characteristics as the main sound. More specifically, the bit depth is 24 bits per sample, the sample rate is 48.000 kHz or 96.000 kHz to match the sample rate of the main sound to the combination, and the channel count is ≤16 full-bandwidth channels. channel), and the reference level reaches−20 dBFS.

The total channel count between the main and auxiliary soundtracks 550, 560 in the CPL 500 is preferably limited to 16 channels. This allows the cinema server 210 (or more precisely the media block (not shown) in the cinema server 210) to process the CPL as both main and secondary sound.

Auxiliary soundtrack file 560 utilizes an additional decryption context. The number of parallel decryption contexts for digital cinema screening may be limited. Thus, the number of auxiliary soundtracks 560 associated with the auxiliary sound assets 540 in the CPL 500 may also be limited.

The reproduction of the auxiliary soundtrack file 560 is preferably synchronized with the reproduction of the main picture track file 545 and the main soundtrack file 550. Sample accuracy is not required, but at least frame accuracy is desired (i.e., sync error will be between +/−1 frame).

Although the main soundtrack file 550 in the CPL 500 can be modified to include an auxiliary soundtrack, such as an additional language soundtrack, one advantage of using the auxiliary sound structure of an embodiment of the present invention is the multiple CPL 500. Is the flexibility to reuse existing soundtrack files 550 and 560 for. For example, consider a case in which the same digital film is screened in an audience mainly speaking Spanish in the first theater 160a and mainly in an English-speaking audience in the second theater 160b.

When using the auxiliary sound structure of the embodiment of the present invention, the same Spanish and English soundtrack files 550 and 560 have two different CPLs, namely a first CPL (using Spanish as the main sound and English as the auxiliary sound) And the second CPL using English as the main sound and Spanish as the auxiliary sound (as shown in FIG. 9). As a result, using the subsidiary sound structure of an embodiment of the present invention is more flexible than providing a main and subsidiary soundtrack file as one main soundtrack file, where embodiments of the present invention are differently fluent in different languages. This is because it only requires changing the link between the sound assets 530 and 540 and the soundtrack files 550 and 560 in the CPL rather than creating a new main soundtrack file for the audience.

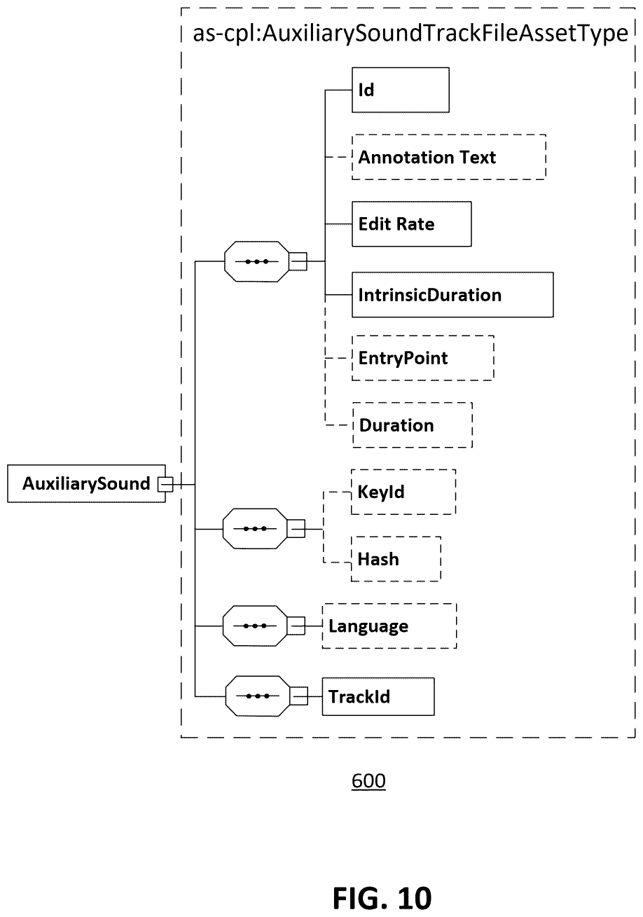

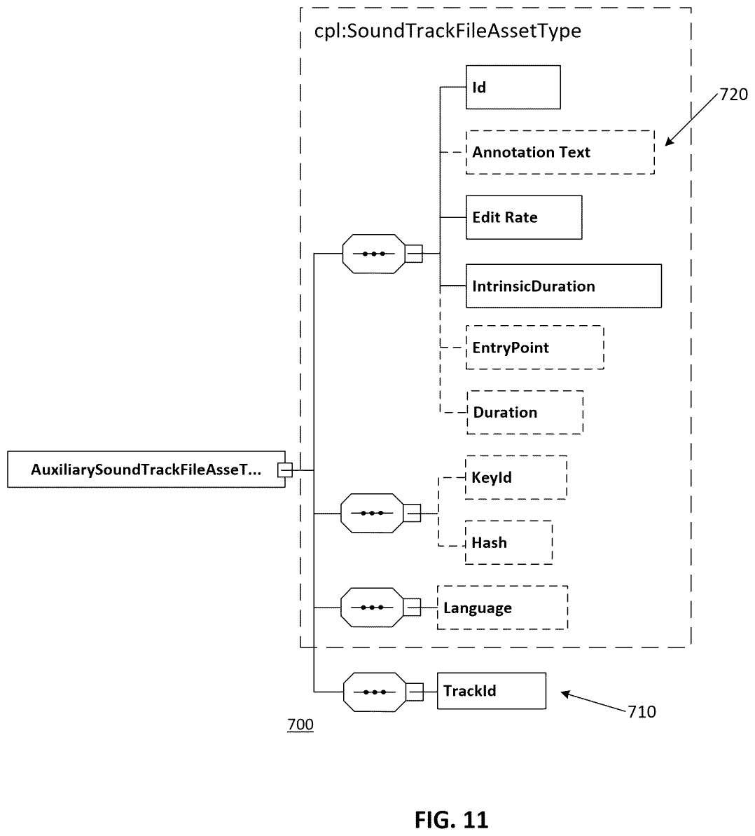

The auxiliary sound structure of an embodiment of the present invention defines additional sound essences that can be played in parallel with the main soundtrack file and other media assets on the reels. In particular, the Auxiliary Sound element (FIG. 10) defines an auxiliary sound essence to be played in the reel, and the Auxiliary Sound Track File Asset Type (FIG. 11) shows a track file containing the auxiliary sound essence.

Referring now to FIG. 10, an auxiliary sound element 600 of one embodiment of the present invention is shown. Auxiliary sound element 600 defines a sound essence for the auxiliary soundtrack to be played on the reel. The actual sound essence is contained in the external track file, as described above. The auxiliary sound element may be defined using the XML schema described below. As shown in FIG. 10, the auxiliary sound element 600 is an instance of an auxiliary sound track file asset type structure. In the CPL, the auxiliary sound element is preferably located within the asset list element of the reel element.

Referring now to FIG. 11, an example of an auxiliary sound track file asset type structure 700 of one embodiment of the present invention is shown. The auxiliary sound track file asset type structure 700 represents a track file that includes an auxiliary sound essence. As mentioned above, an instance of the auxiliary sound track file asset type structure 700 is the auxiliary sound element 600.

The auxiliary sound track file asset type structure 700 is defined using an XML schema, as described below. TrackId element 710 uniquely identifies the secondary soundtrack to which the secondary soundtrack file belongs. The tracked element 710 requires discrimination between different auxiliary soundtracks in reels (eg, reels containing foreign soundtracks and narration soundtracks) that contain a plurality of auxiliary soundtrack files. Annotation Text element 720 is a free form human-readable annotation associated with the auxiliary soundtrack file. The comment element 720 represents the form of at least one of the subsidiary soundtrack files for each subsidiary soundtrack, preferably the first subsidiary soundtrack file. Annotation element 720 illustrates the purpose and use of an auxiliary soundtrack (eg, “second Spanish soundtrack”).

One possible way of integrating auxiliary media content with main screening content is based on XML (extensible Markup Language) standardized plain text computer code. XML is a standardized language used to publish content on the Internet, but it is also used to define data in other areas. In the example of digital cinema, XML is a common language that represents content, content playback methods, captions, and associated metadata.

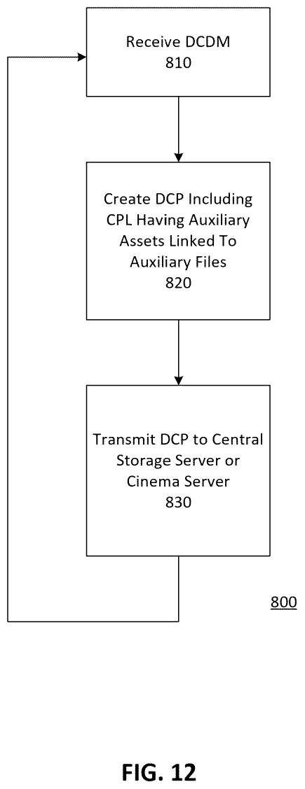

Referring now to FIG. 12, generating a DCP comprising a CPL having auxiliary media assets (eg, auxiliary sound assets) linked to auxiliary media track files (eg, auxiliary soundtrack files) in accordance with one embodiment of the present invention. A flowchart illustrating a process 800 for doing so is shown. In the first step 810, a packaging system (such as packaging system 420 in FIG. 8) receives a DCDM. As mentioned above, the DCDM contains all the digital information (eg, video, audio, and caption) needed for the screening. Next, in step 820, the packaging system compresses, encrypts, and packages the video, audio, and description subtitles included in the DCDM to form a DCP. This DCP includes an essence to be provided, including a compressed and encrypted track file containing video, audio and descriptive caption data, and in particular a CPL indicating how this track file will be played.

According to an embodiment of the present invention, in addition to the main asset (eg, main video, audio and caption subtitle assets) linked to the main track file (e.g., main video, audio and caption track files), the CPL is associated with the main asset. Also included are auxiliary assets (eg, auxiliary sound assets) linked to auxiliary track files (eg, auxiliary soundtracks) to be processed and provided in parallel with the main track file. Next, in step 830, the DCP stores a central storage server (such as the central storage server 130 shown in FIG. 5) or a cinema server (such as the cinema server 210 shown in FIG. 6) according to the arrangement of the digital cinema system. After the DCP has been sent, the packaging system returns to step 810 and waits for receipt of subsequent DCDM.

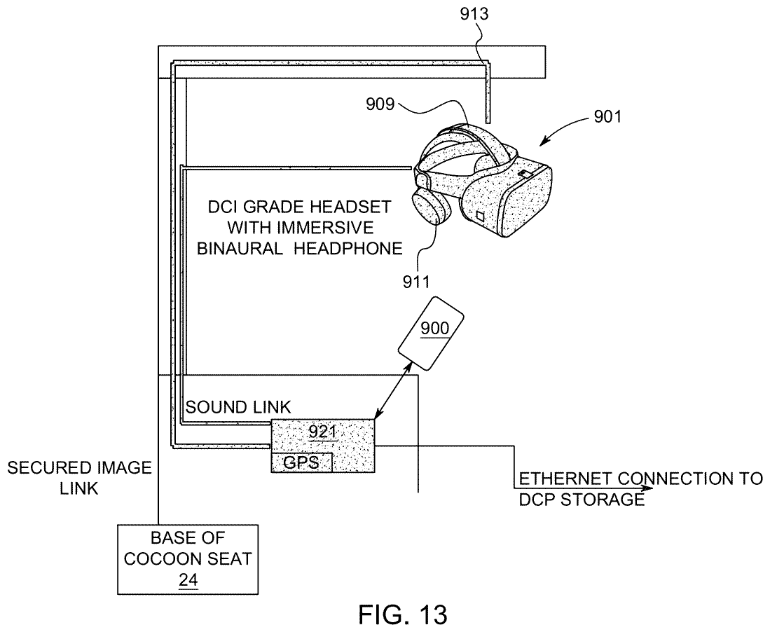

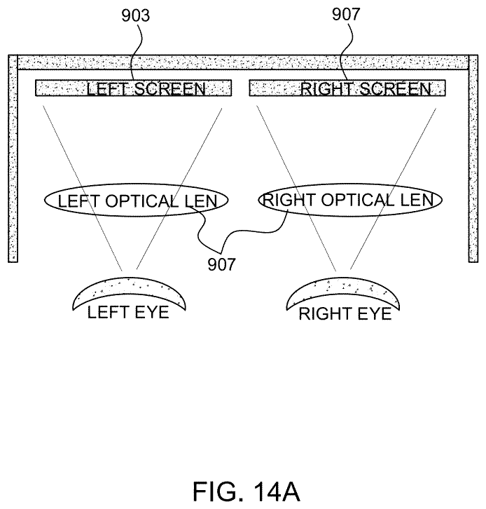

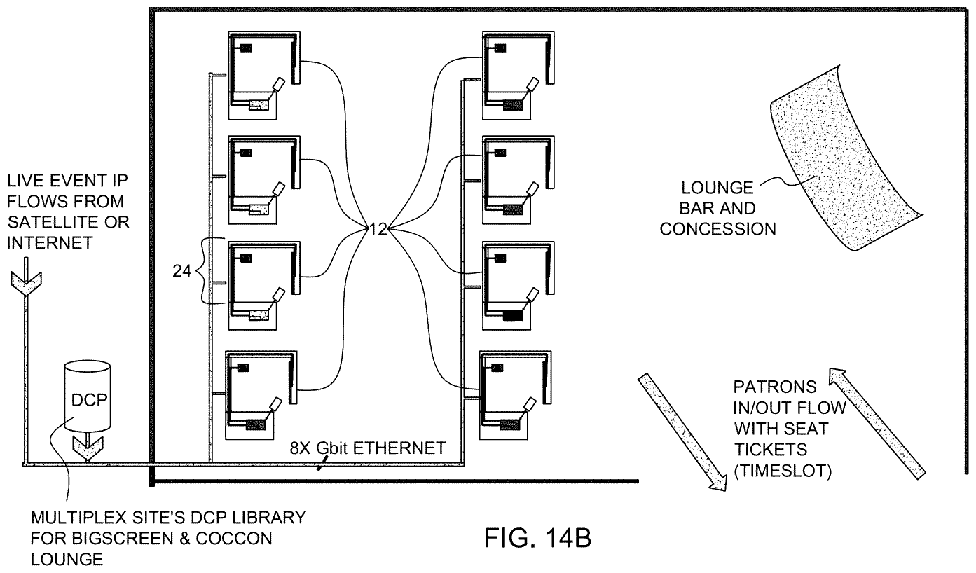

Referring now to FIGS. 13, 14(a) and 14(b), In one embodiment, each seat 12 has a headset 901 with two embedded mini screens 903 and 905 and a lens 907.

In one embodiment, headset 901 includes a headband 909 with padding. In one embodiment, headband 909 is adjustable and rests on top of the user's head. This provides stability and support for headset 901 with padding to ensure comfort during prolonged use.

In one embodiment, headset 901 delivers audio output directly to the user's ears. As a non-limiting example, headset 901 uses high fidelity speakers 911 to be able to render stereo or binaural audio content. Connectivity ports 913 are provided that provide one or more HDMI connection and an Ethernet connection. Connectively ports 913 are coupled to the DCI media server 915 with a DCI marriage setup for DCI security.

In one embodiment, headset 901 includes first and second display screens 903 and 905. Screens 903 and 905 provide the user, viewer, with a feeling of depth and ab angle of vision. As a non-limiting example, screens 903 and 905 are at a front of headset 901, with one or lenses 907 positioned between the user's eyes and screens 903 and 905. Screens 903 and 905 are positioned at an interior of headset 901. A user, viewer, sees screens 903 and 905 through one or more lenses 907. As non-limiting examples, lenses are at distances of one inch or less, 0.5 inches from a viewer's eyes. As non-limiting examples, screens 903 and 905 are at distances of one inch or less, 0.5 inches from lenses 907. Lenses 907 can be optical, focusing, and the like.

As a non-limiting example, screens 903 and 907 has an AV connection HDMI to the DCI player 24 that also constitutes a “DCI marriage” linking in a secured way the DCI player 24 and the display set. Only an authorized cinema technician can execute this “DCI marriage” at the installation of the seat with its headset. Once this “DCI marriage” is set then the DCI player can play the Digital Cinema Package files (DCP); if for any reason the AV link between the DCI player 24 and the screen set made of the headset is disconnected then the so called “DCI marriage” is broken and the DCI player cannot any more play the Digital Cinema Package files (DCP) until an authorized technician come back to re-establish the “DCI marriage”.

As a non-limiting example, first and second display screens 903 and 905 have a resolution of 2K DCI (1080*2048), 4K DCI (2160*4096) and the like. A lens 917 is provided to generate a perceived vision field equivalent to a theatrical environment in both angle of vision and depth of image.

In one embodiment, an audio control provides adjustability of audio to the user. As a non-limiting example, audio renders to the user a binaural immersive sound (5.1, 7.1, Atmos, DTS:X).

In one embodiment, headset 901 is coupled to the DCI player 24 of seat 12 with an appropriate audio-visual connection transmitting the various signal, transmits over HDMI cable, transmits left and right and multi-channel big screen multi-screen.

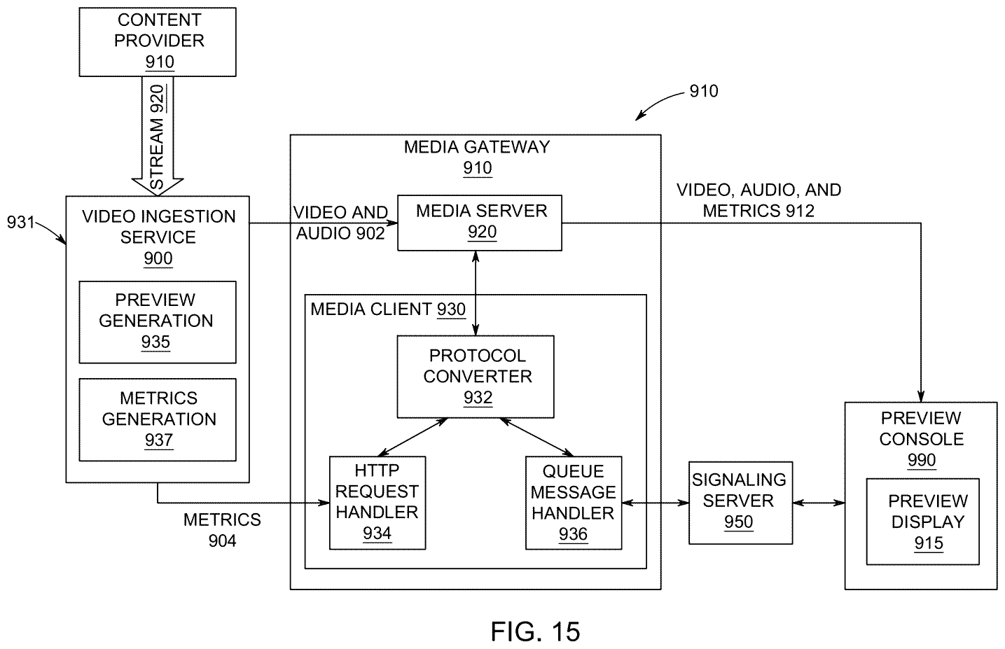

FIG. 15 illustrates one example for viewing streaming video that can be cloud based. This can include a signaling DCI server 921 that establishes a peer connection between a media gateway and a client-side console to which the media gateway sends the video stream, according to one embodiment. A video streaming service 900 may represent a stage of the media delivery pipeline, e.g., the ingestion stage 931. The streaming generation component 935 may generate video and audio 902 of stream representing a lower-bitrate streaming of the ingested stream 920. As also discussed above, the video ingestion service 900 may generate one or more metrics 904 associated with ingestion, e.g., packet loss metrics. Updated elements of the video and audio 902 and the metrics 904 may generated again and again as additional elements of the stream 920 (e.g., additional frames of video) are ingested. The ingestion service 900 may provide the video, audio, and metrics to a media gateway 910.

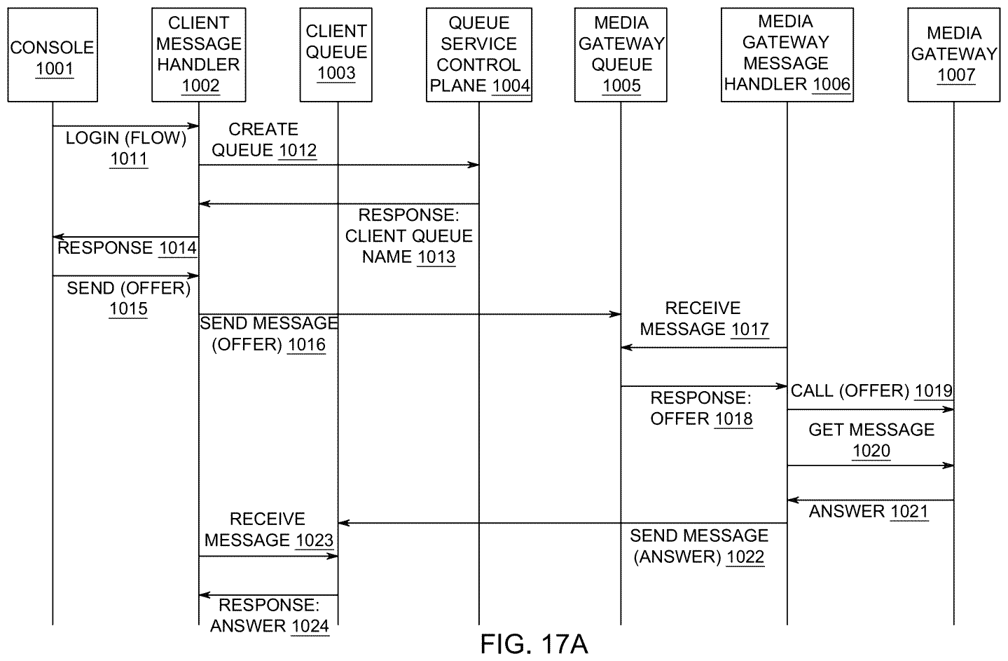

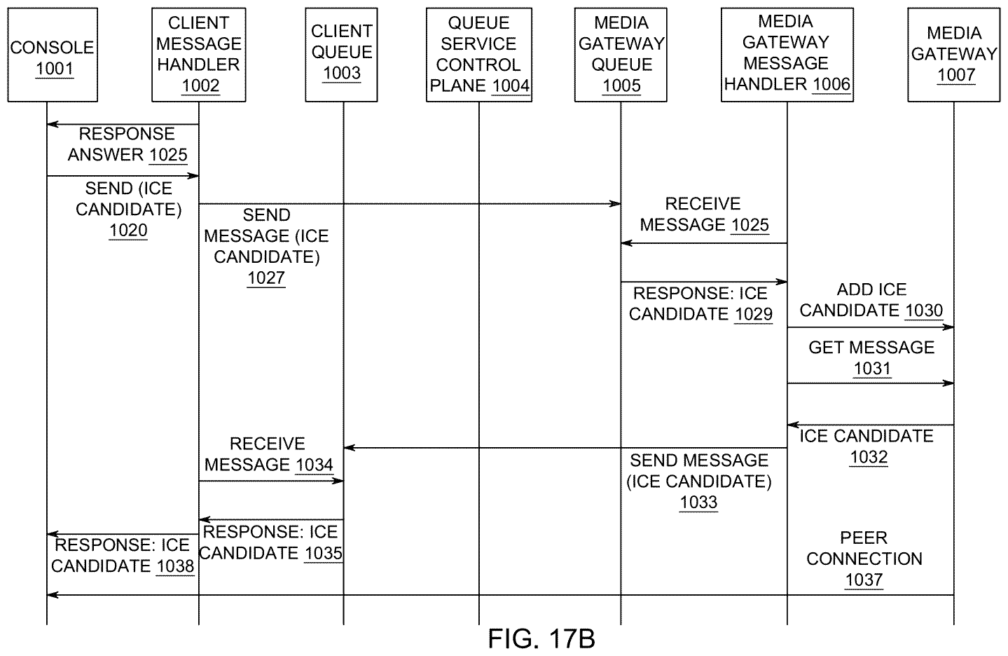

The video streaming and metrics may be transmitted over a peer connection, e.g., using WebRTC or other video conferencing technology. As shown in FIG. 15, a media DCI server 920 and a streaming console 990 may represent the two peers in the connection. The streaming console may be present on a client-side computing device operated by the content provider 910. A signaling DCI server 950 may operate to establish the peer connection. In one embodiment, the signaling DCI server 950 may be implemented using a DCI serverless computation service that performs functions on behalf of a client without the client having responsibility for provisioning or managing DCI servers 950. The signaling DCI server 950 950 may use queues for the media gateway and the client to store messages between those two entities, and the queues may be managed using a queue service. A technique for establishing the peer connection is discussed below with respect to FIGS. 17(a) and 17(b). The media gateway 910 may include the media DCI server 920 and a media client 930. The media client 930 may include a protocol converter 932, an HTTP request handler 934, and a queue message handler 936 that interacts with queues provided by a queue service.

In one embodiment, after the handshaking through the signaling DCI server 950, the media gateway and the console client can communicate through a peer connection, which means that they can communicate with each other directly using their IP addresses and port numbers. In some embodiments, however, most devices are behind one or more layers of NAT (Network Address Translation), and some devices are behind proxies and corporate firewalls. The ICE (interactive connectivity establishment) framework may allow WebRTC to overcome such complexities of real-world networking. The ICE framework may find the best path to connect peers by trying all possibilities in parallel and choosing the most efficient path. ICE may try to make a connection using the host address obtained from a device's operating system and network card. In one embodiment, if the devices are not behind NATs, then this attempt will succeed. Otherwise, ICE may obtain an external address using a STUN (Session Traversal Utilities for NAT) DCI server. If this attempt fails, ICE may route via a TURN (Traversal Using Relay NAT) DCI server. In one embodiment, the STUN DCI server is on the public internet. In one embodiment, the function of STUN DCI server is to check the IP: port of an incoming request and send that address back in a response. An application running behind a NAT may make a request to a STUN DCI server to discover its own IP: port from a public perspective. By doing this, one peer may get a publicly accessible address for itself and pass it to the other peer via signaling DCI server, so that both peers can eventually know the other's address that can be used for communication directly. The fallback TURN DCI server may relay data between endpoints, including streams and metrics data.

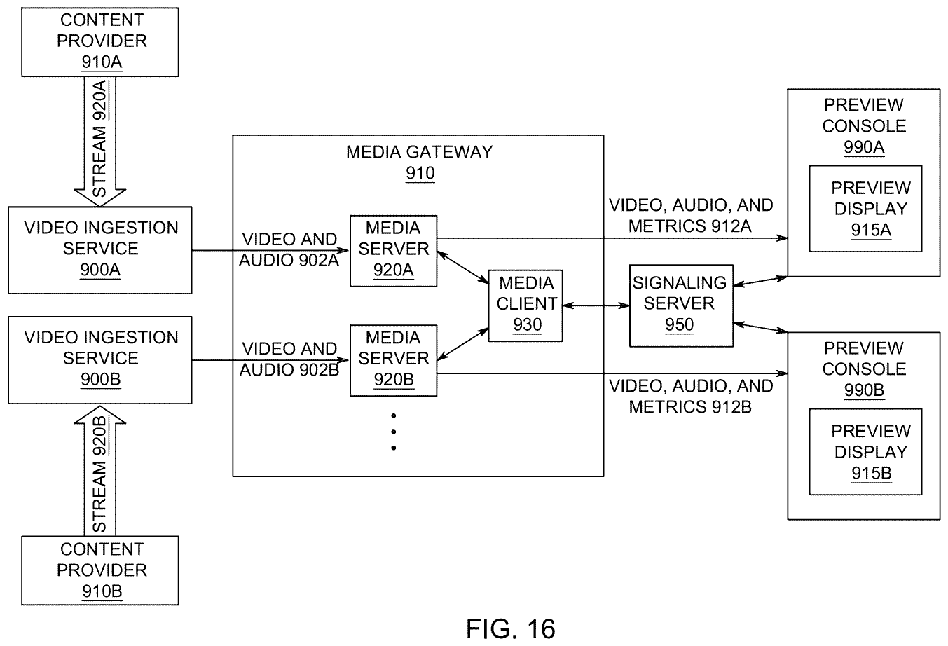

FIG. 16 illustrates further aspects of the example system environment for live streaming of video using the cloud, including the use of multiple media DCI servers 24 with one media client, according to one embodiment. As shown in FIG. 15, the same media gateway 910 and media client 930 may be used to handle video streaming for multiple streams to multiple streaming consoles. A content provider 910a may send a stream 1920a over the Internet to one instance or endpoint 00a of the video ingestion service. Similarly, another content provider 110B 910b may send a stream 920b over the Internet to one instance or endpoint 900b of the video ingestion service. An instance of the media gateway 910 may include one media DCI server for each stream, e.g., media DCI server 920a for video and audio information 902a and media DCI server 920b for video and audio information 902b a signaling DCI server 950 and media client 930 may be used to establish peer connections between the media DCI servers and corresponding streaming consoles 990A and 990b. After the connections are established, the media DCI server 920a may send the streaming video, audio, and metrics 912a to the streaming console 990a for display on the streaming display 915a, and the media DCI server 920b may send the streaming video, audio, and metrics 912b to the streaming console 990b for display on the streaming display 915b. The two streaming's 912a and 912b may be streamed in a substantially concurrent manner.

FIGS. 17(a) and 17(b) are timing diagrams illustrating a technique for establishing a peer connection between a media gateway in the cloud and a client-side streaming console, according to one embodiment. As shown in 1011, the streaming console 1001 may request to login to a client message handler of the signaling DCI server 950 and may supply an identifier of the flow to be streamed. The client message handler 1002 may use the flow identifier to look up the media gateway queue name to which the flow is mapped. As shown in 1012, the client message handler 1002 may also create a client queue in the queue service control plane 1004 and generate the credentials of a TURN DCI server for this streaming console. As shown in 1013 and 1014, the console 1001 may receive a response indicating ICE DCI server information, the media gateway queue name, and the client queue name. After this registration succeeds, as shown in 1015 and 1016, the console 1001 may establish a video conferencing (e.g., WebRTC) connection to the appropriate media gateway 1007 by calling the send function in the client message handler to enqueue the session description protocol (SDP) and interactive connectivity establishment (ICE) information to the media gateway queue 1005. As shown in 1017, 1018, 1019, and 1020, the media gateway message handler 1006 may then dequeue the message from the media gateway queue 1005 and pass it to the media gateway 1007. As shown in 1021 and 1022, the media gateway message handler 1006 may also get response messages from the media gateway and enqueue them to the appropriate client queue 1003; these messages can be dequeued if the console calls the receive function in the client message handler as shown in 1023 and 1024.

In one embodiment, digital video system 10 uses artificial intelligence (AI), to assist viewers modify and create video streams. Employees and contractors with digital video system can also user the AI. As a non-limiting example, the AI creates background animated images & sound to extend a viewer's or user experience using the device, and/or provide analysis of user content consumption to recommend other content among the available content library

In one embodiment, all components of digital video system 10 can have access and use the AI. Examples of AI used include but are not limited to including linear regression, logistic regression, decision tree, SVM algorithm, Naive B ayes algorithm, KNN algorithm, K-means, random forest algorithm, dimensionality reduction, and the like.

As a non-limiting example, a K-means algorithm is used.

In one embodiment, a user can seek from system 10 a recommendation from the server and/or a recommendation engine. The recommendation engine contains identifications and profiles of users who have posted recommendations/ratings, as well as profiles for users and usage feedback for videos and streamed media. A user seeking to use the engine is presented (at some time) with a set of questions or the system otherwise obtains data inputs defining the characteristics of the user. In this case, the user characteristics generally define the context which is used to interpret or modify the basic goal of the user, and therefore the reference-user(s) for the user, though the user may also define or modify the context at the time of use. Various considerations are used in a cluster analysis, in which recommendations relevant to the contexts may be presented, with a ranking according to the distance function from the “cluster definition”. As discussed above, once the clustering is determined, advertisements may be selected as appropriate for the cluster, to provide a subsidy for operation of the system and also to provide relevant information for the user about available products.

Clustering algorithms partition data into a certain number of clusters (groups, subsets, or categories). Important considerations include feature selection or extraction (choosing distinguishing or important features, and only such features); Clustering algorithm design or selection (accuracy and precision with respect to the intended use of the classification result; feasibility and computational cost; etc.); and to the extent different from the clustering criterion, optimization algorithm design or selection.

Finding nearest neighbors can require computing the pairwise distance between all points. However, clusters and their cluster prototypes might be found more efficiently. Assuming that the clustering distance metric reasonably includes close points, and excludes far points, then the neighbor analysis may be limited to members of nearby clusters, thus reducing the complexity of the computation.

There are generally three types of clustering structures, known as partitional clustering, hierarchical clustering, and individual clusters. The most commonly discussed distinction among different types of clustering's is whether the set of clusters is nested or unnested, or in more traditional terminology, hierarchical or partitional. A partitional clustering is simply a division of the set of data objects into non-overlapping subsets (clusters) such that each data object is in exactly one subset. If the clusters have sub-clusters, then we obtain a hierarchical clustering, which is a set of nested clusters that are organized as a tree. Each node (cluster) in the tree (except for the leaf nodes) is the union of its children (sub-clusters), and the root of the tree is the cluster containing all the objects. Often, but not always, the leaves of the tree are singleton clusters of individual data objects. A hierarchical clustering can be viewed as a sequence of partitional clustering's and a partitional clustering can be obtained by taking any member of that sequence; i.e., by cutting the hierarchical tree at a particular level.

There are many situations in which a point could reasonably be placed in more than one cluster, and these situations are better addressed by non-exclusive clustering. In the most general sense, an overlapping or non-exclusive clustering is used to reflect the fact that an object can simultaneously belong to more than one group (class). A non-exclusive clustering is also often used when, for example, an object is “between” two or more clusters and could reasonably be assigned to any of these clusters. In a fuzzy clustering, every object belongs to every cluster with a membership weight. In other words, clusters are treated as fuzzy sets. Similarly, probabilistic clustering techniques compute the probability with which each point belongs to each cluster.

In many cases, a fuzzy or probabilistic clustering is converted to an exclusive clustering by assigning each object to the cluster in which its membership weight or probability is highest. Thus, the inter-cluster and intra-cluster distance function is symmetric. However, it is also possible to apply a different function to uniquely assign objects to a particular cluster.

A well-separated cluster is a set of objects in which each object is closer (or more similar) to every other object in the cluster than to any object not in the cluster. Sometimes a threshold is used to specify that all the objects in a cluster must be sufficiently close (or similar) to one another. The distance between any two points in different groups is larger than the distance between any two points within a group. Well-separated clusters do not need to be spherical, but can have any shape.

If the data is represented as a graph, where the nodes are objects and the links represent connections among objects, then a cluster can be defined as a connected component; i.e., a group of objects that are significantly connected to one another, but that have less connected to objects outside the group. This implies that each object in a contiguity-based cluster is closer to some other object in the cluster than to any point in a different cluster.

A density-based cluster is a dense region of objects that is surrounded by a region of low density. A density-based definition of a cluster is often employed when the clusters are irregular or intertwined, and when noise and outliers are present. DBSCAN is a density-based clustering algorithm that produces a partitional clustering, in which the number of clusters is automatically determined by the algorithm. Points in low-density regions are classified as noise and omitted; thus, DBSCAN does not produce a complete clustering.

A prototype-based cluster is a set of objects in which each object is closer (more similar) to the prototype that defines the cluster than to the prototype of any other cluster. For data with continuous attributes, the prototype of a cluster is often a centroid, i.e., the average (mean) of all the points in the cluster. When a centroid is not meaningful, such as when the data has categorical attributes, the prototype is often a medoid, i.e., the most representative point of a cluster. For many types of data, the prototype can be regarded as the most central point. These clusters tend to be globular. K-means is a prototype-based, partitional clustering technique that attempts to find a user-specified number of clusters (K), which are represented by their centroids. Prototype-based clustering techniques create a one-level partitioning of the data objects. There are a number of such techniques, but two of the most prominent are K-means and K-medoid. K-means defines a prototype in terms of a centroid, which is usually the mean of a group of points, and is typically applied to objects in a continuous n-dimensional space. K-medoid defines a prototype in terms of a medoid, which is the most representative point for a group of points, and can be applied to a wide range of data since it requires only a proximity measure for a pair of objects. While a centroid almost never corresponds to an actual data point, a medoid, by its definition, must be an actual data point.

In the k-means clustering technique K initial centroids are selected, the number of clusters desired. Each point in the data set is then assigned to the closest centroid, and each collection of points assigned to a centroid is a cluster. The centroid of each cluster is then updated based on the points assigned to the cluster. We iteratively assign points and update until convergence (no point changes clusters), or equivalently, until the centroids remain the same. For some combinations of proximity functions and types of centroids, K-means always converges to a solution; i.e., K-means reaches a state in which no points are shifting from one cluster to another, and hence, the centroids don't change. Because convergence tends to b asymptotic, the end condition may be set as a maximum change between iterations. Because of the possibility that the optimization results in a local minimum instead of a global minimum, errors may be maintained unless and until corrected. Therefore, a human assignment or reassignment of data points into classes, either as a constraint on the optimization, or as an initial condition, is possible.

To assign a point to the closest centroid, a proximity measure is required. Euclidean (L2) distance is often used for data points in Euclidean space, while cosine similarity may be more appropriate for documents. However, there may be several types of proximity measures that are appropriate for a given type of data. For example, Manhattan (L1) distance can be used for Euclidean data, while the Jaccard measure is often employed for documents. Usually, the similarity measures used for K-means are relatively simple since the algorithm repeatedly calculates the similarity of each point to each centroid, and thus complex distance functions incur computational complexity. The clustering may be computed as a statistical function, e.g., mean square error of the distance of each data point according to the distance function from the centroid. Note that the K-means may only find a local minimum, since the algorithm does not test each point for each possible centroid, and the starting presumptions may influence the outcome. The typical distance functions for documents include the Manhattan (L1) distance, Bregman divergence, Mahalanobis distance, squared Euclidean distance and cosine similarity.

An optimal clustering will be obtained as long as two initial centroids fall anywhere in a pair of clusters, since the centroids will redistribute themselves, one to each cluster. As the number of clusters increases, it is increasingly likely that at least one pair of clusters will have only one initial centroid, and because the pairs of clusters are further apart than clusters within a pair, the K-means algorithm will not redistribute the centroids between pairs of clusters, leading to a suboptimal local minimum. One effective approach is to take a sample of points and cluster them using a hierarchical clustering technique. K clusters are extracted from the hierarchical clustering, and the centroids of those clusters are used as the initial centroids. This approach often works well, but is practical only if the sample is relatively small, e.g., a few hundred to a few thousand (hierarchical clustering is expensive), and K is relatively small compared to the sample size. Other selection schemes are also available.

The space requirements for K-means are modest because only the data points and centroids are stored. Specifically, the storage required is O((m+K)n), where m is the number of points and n is the number of attributes. The time requirements for K-means are also modest-basically linear in the number of data points. In particular, the time required is O(I×K×m×n), where I is the number of iterations required for convergence. As mentioned, I is often small and can usually be safely bounded, as most changes typically occur in the first few iterations. Therefore, K-means is linear in m, the number of points, and is efficient as well as simple provided that K, the number of clusters, is significantly less than m.

Outliers can unduly influence the clusters, especially when a squared error criterion is used. However, in some clustering applications, the outliers should not be eliminated or discounted, as their appropriate inclusion may lead to important insights. In some cases, such as financial analysis, apparent outliers, e.g., unusually profitable investments, can be the most interesting points.

Hierarchical clustering techniques are a second important category of clustering methods. There are two basic approaches for generating a hierarchical clustering: Agglomerative and divisive. Agglomerative clustering merges close clusters in an initially high dimensionality space, while divisive splits large clusters. Agglomerative clustering relies upon a cluster distance, as opposed to an object distance. For example, the distance between centroids or medoids of the clusters, the closest points in two clusters, the further points in two clusters, or some average distance metric. Ward's method measures the proximity between two clusters in terms of the increase in the sum of the squares of the errors that results from merging the two clusters.

Agglomerative Hierarchical Clustering refers to clustering techniques that produce a hierarchical clustering by starting with each point as a singleton cluster and then repeatedly merging the two closest clusters until a single, all-encompassing cluster remains. Agglomerative hierarchical clustering cannot be viewed as globally optimizing an objective function. Instead, agglomerative hierarchical clustering techniques use various criteria to decide locally, at each step, which clusters should be merged (or split for divisive approaches). This approach yields clustering algorithms that avoid the difficulty of attempting to solve a hard combinatorial optimization problem. Furthermore, such approaches do not have problems with local minima or difficulties in choosing initial points. Of course, the time complexity of O(m2 log m) and the space complexity of O(m2) are prohibitive in many cases. Agglomerative hierarchical clustering algorithms tend to make good local decisions about combining two clusters since they can use information about the pair-wise similarity of all points. However, once a decision is made to merge two clusters, it cannot be undone at a later time. This approach prevents a local optimization criterion from becoming a global optimization criterion.

In supervised classification, the evaluation of the resulting classification model is an integral part of the process of developing a classification model. Being able to distinguish whether there is non-random structure in the data is an important aspect of cluster validation.

In one embodiment, a k-means algorithm is used as follows:

The K Means Clustering algorithm finds observations in a dataset that are like each other and places them in a set. The process starts by randomly assigning each data point to an initial group and calculating the centroid for each one. A centroid is the center of the group. Note that some forms of the procedure allow you to specify the initial sets.

Then the algorithm continues as follows:

It evaluates each observation, assigning it to the closest cluster. The definition of “closest” is that the Euclidean distance between a data point and a group's centroid is shorter than the distances to the other centroids.

When a cluster gains or loses a data point, the K means clustering algorithm recalculates its centroid.

The algorithm repeats until it can no longer assign data points to a closer set.

When the K means clustering algorithm finishes, all groups have the minimum within-cluster variance, which keeps them as small as possible. Sets with minimum variance and size have data points that are as similar as possible. There is variability amongst the characteristics in each cluster, but the algorithm minimizes it.

In short, the observations within a set should share characteristics. Be sure to assess the final groups to be sure they make sense and satisfy your goals! In some cases, the analysts might need to specify different numbers of groups to determine which value of K produces the most useful results.

Each of the following references is expressly incorporated herein by reference in its entirety:
Abraham, Ittai, et al. “Low-distortion inference of latent similarities from a multiplex social network.” SIAM Journal on Computing 44.3 (2015): 617-668.
Aldenderfer, M. S., and R. K. Blashfield. Cluster Analysis. Sage Publications, Los Angeles, 1985.
Anderberg, M. R. (1973). Cluster Analysis for Applications. Academic Press, New York.
Anderson, E. (1957). A semi-graphical method for the analysis of complex problems. Proc. Nat. Acad. Sci. USA 43923-927.
Anderson, T. W. (1958). An Introduction to Multivariate Statistical Analysis. Wiley, New York.
Anderson, T. W., and Bahadur, R. R. (1962). classification into two multivariate normal distributions with different covariance matrices. Ann. Math. Statist. 33420-431.
Andrews, D. F. (1972). Plots of high-dimensional data. Biometrics 28 125-136.
Ankerst, M., M. M. Breunig, H.-P. Kriegel, and J. Sander. OPTICS: Ordering Points To Identify the Clustering Structure. In Proc. of 1999 ACM-SIGMOD Intl. Conf. on Management of Data, pages 49-60, Philadelphia, Pa., June 1999. ACM Press.
Arabie, P. (1977). clustering representations of group overlap. J. Math. Soc. 5 112-128.
Arabie, P. and Carroll, J. D. (1980). MAPCLUS: A mathematical programming approach to fitting to ADCLUS model. Psychometrika 45211-235.
Arabie, P., L. Hubert, and G. D. Soete. An overview of combinatorial data analysis. In P. Arabie, L. Hubert, and G. D. Soete, editors, Clustering and Classification, pages 188-217. World Scientific, Singapore, January 1996.
Art, D., Gnanadesikan, R., and Kettenring, J. R. (1982). Data-based metrics for cluster analysis. Utilitas Mathematica 31A 75-99.
Asimov, D. (1985). The grand tour. SLAM J. Sci. Statist. Corn-put. 6 128-143.
Auffarth, Benjamin, Yasumasa Muto, and Yasuharu Kunii. “An artificial system for visual perception in autonomous Robots.” Proceedings of the IEEE International Conference on Intelligent Engineering Systems. 2005.
Babu, B. Hari, N. Subash Chandra, and T. Venu Gopal. “Clustering Algorithms For High Dimensional Data—A Survey Of Issues And Existing Approaches.”
Baker, F. B. (1974). Stability of two hierarchical grouping techniques, Case I: Sensitivity to data errors. J. Amer. Statist. Assoc. 69440-445.
Ball, G., and D. Hall. A Clustering Technique for Summarizing Multivariate Data. Behavior Science, 12:153-155, March 1967.
Banerjee, A., S. Merugu, I. S. Dhillon, and J. Ghosh. Clustering with Bregman Divergences. In Proc. of the 2004 SIAM Intl. Conf. on Data Mining, pages 234-245, Lake Buena Vista, Fla., April 2004.
Baraglia, R., Dazzi, P., Mordacchini, M., & Ricci, L. (2013). A peer-to-peer recommender system for self-emerging user communities based on gossip overlays. Journal of Computer and System Sciences, 79(2), 291-308.
Baragliaa, R., Dazzia, P., Mordacchinib, M., & Riccic, L. A Peer-to-Peer Recommender System for self-emerging user communities based on Gossip Overlays. (2012)
Beck, Carolyn, et al. “Dynamic Coverage and Clustering: A Maximum Entropy Approach.” Distributed Decision Making and Control. Springer London, 2012. 215-243.
Becker, P. (1968). Recognitions of Patterns. Polyteknisk, Copenhagen.
Bell, P. A. and Korey, J. L. (1975). QUICLSTR: A FORTRAN program for hierarchical cluster analysis with a large number of subjects. Behavioral Research Methods and Instrumentation 7575.
Berg, Mikko. “Human abilities to perceive, understand, and manage multi-dimensional information with visualizations.” (2012).
Birkin, P. Survey Of Clustering Data Mining Techniques. Technical report, Accrue Software, San Jose, Calif., 2002.
Bhat, Sajid Yousuf, and Muhammad Abulaish. “A density-based approach for mining overlapping communities from social network interactions.” Proceedings of the 2nd International Conference on Web Intelligence, Mining and Semantics. ACM, 2012.
Binder, D. A. (1978). Comment on ‘Estimating mixtures of normal distributions and switching regressions’. j Amer. Statist. Assoc. 73746-747.
Blashfield, R. K., Aldenderfer, M. S. and Morey, L. C. (1982). cluster analysis literature on validation. In Classifying Social Data. (H. Hudson, ed.) 167-176. Jossey-Bass, San Francisco.
Bock, H. H. (1985). On significance tests in cluster analysis. J. Classification 277-108.
Boley, D. Principal Direction Divisive Partitioning. Data Mining and Knowledge Discovery, 2(4):325-344, 1998.
Bosley, Daniel, and Vivian Borst. “A General Unsupervised Clustering Tool for Unstructured Data.” matrix 100: 2.
Boratto, Ludovico. “Group recommendation with automatic detection and classification of groups.” (2012).
Bradley, P. S. and U. M. Fayyad. Refining Initial Points for K-Means Clustering. In Proc. of the 15th Intl. Conf. on Machine Learning, pages 91-99, Madison, Wis., July 1998. Morgan Kaufmann Publishers Inc.
Breiman, L. Meisel, W. S., and Purcell, E. (1977). Variable kernel estimates of multivariate densities and their calibration. Technometrics 19 135-144.
Brineman, L., Friedman, J. H., Olshen, R. A., and Stone, C. J. (1984). Classification and Regression Trees. Wadsworth, Belmont, Calif.
Broadbent, S. R. and Hammersley, J. M. (1957). Percolation Processes, I: Crystals and Mazes. Proc. Cambridge Philos. Soc. 53629-641.
Bu, Yingyi, et al. “The HaLoop approach to large-scale iterative data analysis.” The VLDB Journal—The International Journal on Very Large Data Bases 21.2 (2012): 169-190.
Buja, A., Hurify, C. and Mcdonald, J. A. (1986). A data viewer for multivariate data. Computer Science and Statistics: Proceedings of the 18th Symposium on the Interface 171-174.
Cacoullos, T. (1966). Estimation of a multivariate density. Ann. Math. Statist. 18 179-189.
Cal, Rui, et al. “Scalable music recommendation by search.” Proceedings of the 15th international conference on Multimedia. ACM, 2007.
Carrizosa, Emilio, and Dolores Romero Morales. “Supervised classification and mathematical optimization.” Computers & Operations Research 40.1 (2013): 150-165.
Chang, Chin-Chun, and Hsin-Yi Chen. “Semi-supervised clustering with discriminative random fields.” Pattern Recognition 45.12 (2012): 4402-4413.
Chen, H., Gnanadesikan, R., and Kettenring, J. R. (1974). Statistical methods for grouping corporations. Sankhya B 36 1-28.
Chen, Yen Hung. “The k Partition-Distance Problem.” Journal of Computational Biology 19.4 (2012): 404-417.
Cheng, Hong, et al. “Clustering large attributed information networks: an efficient incremental computing approach.” Data Mining and Knowledge Discovery 25.3 (2012): 450-477.
Chernoff, H. (1972). The selection of effective attributes for deciding between hypotheses using linear discriminant functions. In Frontiers of Pattern Recognition. (S. Watanabe, ed.) 55-60. Academic Press, New York.
Chernoff, H. (1973a). Some measures for discriminating between normal multivariate distributions with unequal covariance matrices. In Multivariate Analysis Ill. (P. R. Krishnaiah, ed.) 337-344. Academic Press, New York.
Chernoff, H. (1973b). The use of faces to represent points in k-dimensional space graphically. J Amer. Statist. Assoc. 68 361-368.
Cherubini, Umberto, and Agnese Sironi. Bond Trading, Market Anomalies and Neural Networks: An Application with Kohonen Nets. No. _012. Society for Computational Economics.
Christou, Ioannis T., George Gekas, and Anna Kyrikou. “A classifier ensemble approach to the TV-viewer profile adaptation problem.” International Journal of Machine Learning and Cybernetics 3.4 (2012): 313-326.
Clunies-Ross, C. W. and Riffenburgh, R. H. (1960). Geometry and linear discrimination. Biometrika 47185-189.
Cormack, R. M. (1971). A review of classification (with discussion). J Roy. Statist. Soc. A 134321-367.
Cover, T. M. (1968). Estimation by the nearest neighbor rule. IEEE Transactions Information Theory IT-14 50-55.
Cover, T. M. and Hart, P. E. (1967). Nearest neighbor pattern classification. IEEE Transactions, Information Theory IT-13 21-27.
Dallal, G. E. (1975) A user's guide to J. A. Hartigan's clustering algorithms. (unpublished manuscript) Yale University.
Day, N. E. (1969). Estimating the components of a mixture of normal distributions. Biometrika 56463-474.
Day, N. E., and Kerridge, D. F., (1967). A general maximum likelihood discriminant. Biometrics 23313-323. 94
de Master, Trabajo Fin. “Novelty and Diversity Enhancement and Evaluation in Recommender Systems.” (2012).
Defays, D. (1977). An efficient algorithm for a complete link method. Computer Journal 20364-366.
Derrac, Joaquin, Isaac Triguero, Salvador Garcia, and Francisco Herrera. “Integrating instance selection, instance weighting, and feature weighting for nearest neighbor classifiers by coevolutionary algorithms.”

It is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

1. A digital video system at a cinema, comprising:
a plurality of personal cinema experience area seats for viewing at least one of a program playing the cinema or stream able to the cinema, each of a seat plurality of personal cinema experience area seats is positioned at a selected area of the cinema;
a headset at each of the plurality of personal cinema experience area seats including two embedded mini screens and a lens one or more speakers at each of a seat; and
a DCI compliant cinema player for each seat of the plurality of personal cinema experience area seat.

2. The system of claim 1, wherein the speakers are provided in a headphone.

3. The system of claim 1, wherein at each of a seat associated with speakers that play a program sound track to the seat occupant.

4. The system of claim 1, wherein the program is a video with audio that includes other related information synchronized with it.

5. The system of claim 2, wherein the related information is selected from at least one of: a special visual signal channel for the visually impaired; subtitling for a different language; a multimedia channel; a visual signal channel for the visually impaired; and subtitling for a different language.

6. The system of claim 1, wherein the program is one or more of: a long program; and a short program.

7. The system of claim 1, wherein the personal cinema experience area is an area of the cinema wherein viewers of a program can select one or more programs to view.

8. The system of claim 1, wherein the personal cinema experience area provides a private experience for viewing a program.

9. The system of claim 1, wherein each of a seat of the plurality provides a seat occupant with a similar DCI quality experience for a personal cinema experience;

10. The system of claim 1, wherein each of a seat of the plurality includes an individual viewer control of a user interface.

11. The system of claim 1, wherein each of a seat of the plurality is associated with an individual emissive screen.

12. The system of claim 9, Wherein each of an emissive screen is compliant with DCI display rules relative to a visual quality experience (DCI/CTP compliance).

13. The system of claim 8, wherein each of a user interface runs on a tablet.

14. The system of claim 8, wherein each of a user interface allows a viewer to browse through one or more of a: day; time; and a list of programs shown at cinema as well as those available to be streamed to the cinema.

15. The system of claim 12, wherein a viewer is able to view programs available at the cinema by selecting a title and playing it.

16. The system of claim 13, wherein a viewer is able to pause a program.

17. The system of claim 13, wherein each seat includes active seat localization that determines if the seat has been moved and prevents any further playback

18. The system of claim 13, further comprising:
a movement mechanism that allows 1 movement of a display screen in order for individual to see the display screen at a desired position.

19. The system of claim 18, wherein the movement mechanism allows a viewer to adjust a position of a display screen for improved viewing.

20. The system of claim 13, wherein the DCI is at a base of a seat.
